(19) United States
(12) Patent Application Publication
(10) Pub. No.: US 2015/0171587 A1
(43) Pub. Date: Jun. 18, 2015

(54) Solid-State Laser Arrangement

(71) Applicant: TRUMPF LASER GMBH, Schramberg (DE)

(72) Inventors: Sven-Silvius Schad, Rottweil (DE); Christian Stolzenburg, Rottweil (DE); Alexander Killi, Trossingen (DE)

(21) Appl. No.: 14/628,783

(22) Filed: Feb. 23, 2015

Related U.S. Application Data
(63) Continuation of application No. PCT/EP2013/067086, filed on Aug. 15, 2013.

(30) Foreign Application Priority Data
Aug. 23, 2012 (DE) 102012214970.8

(51) Int. Cl. H01S 3/042

(52) U.S. Cl. CPC H01S 3/042

(57) ABSTRACT

A solid-state laser arrangement, including a plate-like solid body with a laser-active medium, in which the plate-like solid body includes an upper side, a lower side and a circumferential peripheral face, and/or in which a heat sink thermally coupled to the lower side of the plate-like solid body, in which the plate-like solid body includes a scatter region on the upper side and/or on the peripheral face, and the peripheral face of the plate-like solid body includes a portion inclined relative to the upper side and the lower side.

### CROSS-REFERENCE TO RELATED APPLICATION

This application is a continuation of and claims priority under 35 U.S.C. §120 to PCT Application No. PCT/EP2013/067086 filed on Aug. 15, 2013, which claimed priority to German Application No. DE 10 2012 214 970.8, filed on Aug. 23, 2012. The contents of both of these priority applications are hereby incorporated by reference in their entirety.

### TECHNICAL FIELD

The present disclosure relates to a solid-state laser arrangement.

### BACKGROUND

The plate-like solid body (also referred to as a laser disc) is optically excited by a pump light source in order to produce a population inversion in the laser-active solid body material. The output power of the solid-state laser arrangement that is produced when the solid body is pumped is intended to be as large as possible. The output power is limited, among other things, by the maximum pump power of the pump light source or by the fact that the number of cycles of the pump radiation is limited by the laser-active medium.

Another factor that influences the maximum possible amplification of the plate-like solid body is the so-called “Amplification of Spontaneous Emission” (ASE) which is also referred to as superluminescence. The term ASE refers to the (undesirable) amplification of radiation produced by spontaneous emissions of photons in the pumped solid body volume. The amplification expands when the arrangement is viewed in a lateral direction (that is to say, substantially parallel with the upper and lower side of the solid body). If this radiation is not coupled out of the solid body medium to a sufficient extent, there may be an oscillation build-up of undesirable laser modes in the solid body. This/these laser mode(s) resulting from the amplification of spontaneous emission constitute(s) parasitic transverse radiation, which has negative consequences for the laser process.

These negative effects include, for example, overheating of the solid body by which the maximum laser power which can be achieved is reduced. Thermomechanical damage to the solid body may also occur. This damage appears, for example, as erosion, particle flaking or melting of the solid body material. To monitor a solid body, in particular a laser disc, for overheating, it is proposed in DE 10 2008 029 423 B4 to carry out detection of the parasitic transverse radiation.

To reduce the negative consequences of the amplified spontaneous emission, it is known to carry out a coupling out of the spontaneous emissions in the solid body, by so-called “Anti-ASE caps” being fitted to the upper side of the solid body. Such a cap includes a non-doped material that enables spontaneously emitted photons to be decoupled from the doped solid body (the active medium). However, the application of such a cap against amplified spontaneous emissions on the laser disc has the disadvantage that, on the one hand, both the emitted laser radiation and, where applicable, the pump light radiation has to penetrate the cap. Due to the accumulation of heat, this is generally associated with an undesirable thermal lens. Furthermore, the cap must be applied to the laser-active solid body, for example, by bonding, which has to be technologically controlled.

It is also known to fit absorbers to the peripheral face of the solid body (with or without a cap against amplified spontaneous emission) to suppress the reflection of spontaneously emitted photons on the peripheral face of the plate-like solid body. However, when such an absorber is fitted, there is the problem that this may have to absorb a high radiation power and becomes heated so that the absorber may have to be provided with a separate heat sink, which can also lead to problems.

### SUMMARY

An object of the present disclosure is to provide a solid-state laser arrangement which allows the production of high laser powers and which prevents, in certain implementations, the above-mentioned disadvantages.

In general, according to one aspect, the subject matter of the present disclosure is encompassed by a solid-state laser arrangement in which a plate-like solid body has a scatter region that is formed on the upper side and/or on the peripheral face and/or in which the peripheral face of the plate-like solid body has a portion that is inclined relative to the upper side and the lower side. A decoupling of spontaneous emissions produced in the plate-like solid body be carried out, preferably with no additional components (caps or absorbers) having to be fitted to the solid body. Due to the solid-state laser arrangement, spontaneous emissions of photons that occur in the solid body are advantageously coupled out of the solid body before reflections lead to an amplification of the spontaneous emissions and to the formation of parasitic laser modes in the solid body when the laser threshold is exceeded.

The scatter region and/or the inclined portion enable decoupling from the solid body of spontaneously emitted radiation or radiation power that is produced in the pump region of the solid body by amplified spontaneous emissions. In this case, use is made of the fact that, both as a result of the provision of scatter regions and an inclined portion on the solid body, total reflections of the parasitic radiation in the solid body can be reduced.

The plate-like solid body is typically circular, but may in principle also have a different geometry, for example, a rectangular or square geometry. As a laser-active medium, the solid body typically has a host crystal that is selected, for example from the group including, but not limited to, YAG, YVO₄, Y₂O₃, Sc₂O₃, Lu₂O₃, KGdWO4, KYWO4, YAP, YALO, GGG, GSGG, GSAG, LSB, GLOB, FAP, SFAP, YLF, LuAG. The host crystals may each be doped with Yb³⁺ or Nd³⁺, Ho, Tm³, among others, as an active material. The solid body may also be constructed as a semiconductor hetero-structure and, for example, include the materials GaAs and derivatives thereof such as AlInGaAs or GaAsInN, InP and derivatives thereof, GaN and derivatives thereof such as AlInGaN, GaP or derivatives thereof such as AlGaInP, InSb and derivatives thereof, or SbTe and derivatives thereof. The plate-like solid body does not necessarily have to have a planar geometry but may have a constant (spherical) curvature. That is, the upper side and the lower side of the plate-like solid body may be orientated parallel with each other.

The scatter region may be formed by a structured surface or a structured surface region of the solid body. The scatter region is preferably constructed as a roughening on the upper side and/or on the peripheral face of the solid body surface. The scatter region at the upper side of the plate-like solid body may be limited to an edge region of the solid body, in which it is not pumped (i.e., outside the pump spot). The surface structure or roughening may be constructed in a regular manner (for example, in the form of scratches which are arranged in a regular manner). Typically, however, the surface structure that forms the scatter region is irregular, i.e., it has structures which are arranged in a random manner. Due to roughening and/or surface structure, scatter centers are formed at the surface, which decouple the parasitic laser radiation that extends in a transverse manner from the solid body. The scatter face or the roughening may, for example, be produced by a polishing method, a lapping method, a laser ablation process or an ion beam process.

Due to the inclined portion on the peripheral face, the peripheral face deviates from a typically cylindrical geometry that extends perpendicularly relative to the upper and lower side. The inclined portion changes the outer structure of the solid body or the geometry thereof in the region of the peripheral face and may, for example, be produced by a grinding process or a laser removal process. Due to the introduction of a portion whose surface normal deviates from a direction parallel with the upper and lower side of the solid body, a total reflection of the laterally extending spontaneous emissions can be at least partially prevented and these may be coupled out on the inclined portion. The inclined potion may have a planar geometry or optionally have a curvature itself.

In some implementations, the scatter region is constructed as a roughened face. The roughened face may have a roughness Rz between 0.5 μm and 5 μm, preferably between 1 μm and 4 μm or a roughness Ra from 0.01 μm to 0.5 μm, preferably between 0.1 μm and 0.3 μm. With scatter faces having such roughness, total reflections that are produced on the upper side and/or peripheral face can be reduced to a particularly great extent, whereby the decoupling of the parasitic radiation or radiation power is particularly effective.

The scatter region may also be formed by a layer that is selectively applied to the solid body (i.e., limited to a desired region) and that contains scatter bodies. The layer containing scatter bodies may, for example, be a transparent polymer in which nanoparticles, for example, in the form of nanospheres, are embedded as scatter bodies. Such nanospheres are used, for example, as a calibration standard for scanning electron microscopes.

In some implementations, the inclined portion extends from the upper side as far as the lower side of the plate-like solid body. The entire peripheral face of the solid body is consequently constructed as an inclined portion, whereby the decoupling effect of the inclined portion is increased.

Preferably, an inclination angle of the inclined portion is constant along the peripheral face, i.e., the inclined portion forms a chamfer. This advantageously results in the peripheral direction in a uniform decoupling of the radiation that is based on spontaneous emissions and that is propagated in a lateral direction, which leads to a uniform thermo-mechanical loading of the solid body. At constant inclination angles, the danger that, with a high inversion, occurrences of erosion appear at the edge of the laser disc or the solid body, is therefore additionally reduced. A chamfer is consequently particularly suitable for decoupling radiation that is guided laterally in the laser disc. The chamfer is typically formed at the upper side of the solid body and can extend from there to the lower side of the solid body so that the plate-like solid body is frustoconical.

In a preferred implementation, the angle of inclination is between 5° and 40°, preferably between 5° and 15°. With such angles of inclination, in the case of radiation that is propagated substantially in a transverse direction (that is to say, parallel with the upper and lower side), the limit angle of the total reflection on the inclined surface portion is generally not exceeded. With each reflection on the inclined portion, the angle of incidence is reduced by the acute angle of inclination of the inclined portion so that the guided modes are slowly moved into a tapered decoupling portion and, as a result, a discharge of the parasitic radiation on the inclined portion is advantageously promoted.

Due to the inclined portion on the peripheral face, the thickness of the plate-like solid body decreases outwards. Due to the decreasing thickness of the plate-like solid body, there is reduced tension resistance of the solid body in the region of the peripheral face. This is problematic in that the thermal expansion coefficient of the laser-active medium or the solid body typically differs from the thermal expansion coefficient of the heat sink to which the solid body is thermally coupled so that temperature changes may lead to increased internal mechanical tensions. In an extreme case, the increased internal mechanical tensions can lead to tension cracks in the solid body and consequently failure of the solid body.

Preferably, the recesses are formed on the peripheral face that has the inclined portion recesses extending from an outer edge of the lower side of the plate-like solid body in the direction towards the outer edge of the upper side of the plate-like solid body. The recesses preferably extend as far as the outer edge of the upper side of the solid body and optionally beyond. The recesses advantageously bring about a reduction of tension in the region between the edges of the upper and lower side of the solid body, i.e., in the region of the solid body that is affected by the geometric thickness reduction. The recesses may also extend beyond the peripheral face from the outer edge of the upper side further inwards radially. In principle, it is also possible for the recesses to terminate in a radial direction before the outer edge on the upper side of the solid body.

Due to the typically gap-like or slot-like recesses in the solid body material, which extend from the outer edge at the lower side of the solid body in the direction towards the outer edge at the upper side of the solid body (e.g., with a circular geometry of the solid body in a radial direction), tensile stresses in the solid body material acting in the peripheral direction (e.g., in an azimuthal direction) can be decreased. The radially acting shear stresses that occur in the solid body material and that are also brought about by different thermal expansion coefficients of the solid body and the heat sink, can be decreased over the radial location coordinate by appropriate connection technology (e.g., by adhesion or bonding).

The depth of a recess generally corresponds to the thickness of the solid body so that a slot-like recess that extends from the upper side to the lower side is formed. Optionally, the depth of the recess may be smaller than the thickness of the solid body, whereby a pocket-like recess having a pocket or recess base is produced. The longitudinal extent of the recesses extends as set out above preferably in a radial direction (e.g., with a disc-like solid body), but may optionally also deviate, at least partially, from the radial direction. For example, the longitudinal recesses may extend in the peripheral direction. The recesses are generally formed at least in the region of the inclined portion on the peripheral face of the solid body and may, for example, be produced by a laser removal process or erosion.

The recesses may divide the peripheral face into multiple segments that are of the same size. If the recesses extend from the outer edge at the lower side of the plate-like solid body not quite as far as the outer edge on the upper side of the plate-like solid body, only a radially outer region of the peripheral face may be subdivided into multiple segments that are of the same size. In accordance with the number of recesses, the disc-like solid body or the peripheral face thereof is divided into segments of the same size, that is to say, each segment has an extent of the same size in a peripheral direction. Due to the uniform distribution (the retention of a uniform spacing) of the recesses with respect to each other, there is a uniform tension distribution and tension reduction in the solid body. Solid bodies that have comparatively great tapering (e.g., thickness reduction) towards the edge of the solid body thereby have (almost) no tension-related cracks at the edge of the solid body. However, the peripheral face may also be divided into segments of different sizes.

The individual segments of the solid body preferably have a width or an extent measured in the peripheral direction between approximately 500 μm and 5 mm. The width relates in circular solid bodies with radially extending recesses to the radially inner (most narrow) region of the respective solid body segment. Typical diameters of the disc-like solid body are between approximately 4 mm and approximately 25 mm, typical thicknesses are approximately from 50 to 350 μm.

In some implementations, the recesses are less than 150 μm, preferably less than 110 μm wide. Such comparatively small recess widths may, for example, be achieved by laser processing the plate-like solid body. Due to the small transverse extent of the recesses, only a small removal of material is required and it can additionally be ensured in the case of continuous recesses that the surface at the lower side of the solid body, which is in thermal contact with the heat sink, is not excessively reduced by the recesses.

In some implementations, each one of the segments is formed at a region of the peripheral face diametrically opposite a respective recess. It is advantageous for the recesses not to be arranged diametrically opposed to each other i.e., when two of the recesses do not extend along a common connection axis that may extend through the center of the laser disc, for example, with a circular solid body. Two recesses facing each other may optionally act as two mirror faces between which a stationary wave is produced along the connection axis, while decoupling always takes place at one segment. The condition that the recesses are not intended to be diametrically opposite each other is automatically complied with when the peripheral face is sub-divided into an uneven number of segments of equal size.

In some implementations, the recesses open in the region of the outer edge of the peripheral face that is formed at the upper side of the plate-like solid body in an in particular circular end portion whose transverse extent is increased with respect to a transverse extent of the recesses on the (remaining) peripheral face. The weakening of the solid body that may bring about the introduction of a recess into the solid body, for example, with respect to a notch effect of the recess (i.e., from tension peaks in the solid body material), can be reduced by the provision of an expanded end portion since the tensions in the end portion are distributed over a larger volume than would be the case if the width of the recesses were maintained.

It is generally advantageous for the recesses not to have any significantly varying or abrupt contour changes to prevent tension peaks in the solid body. Even when no expanded end portion is provided in the recesses to reduce the notch effect, it has been found to be advantageous for these to open in a rounded, preferably substantially cylindrical or conical end portion.

In some implementations, the scatter region and/or the inclined portion is/are formed in an edge region of the solid body that extends from an outer edge of the solid body in the direction towards a center axis of the solid body, the extent of the edge region being between 30% and 50%, and preferably between 35% and 45%, of the entire extent of the solid body from the outer edge as far as the center axis. The edge region is located outside the active region, in which pump radiation is irradiated onto the solid body or there is produced in the laser-active medium of the solid body laser radiation that is discharged over the upper side of the solid body. The decoupling of parasitic radiation is intended to take place only outside the active region (pump spot). Compliance with the relationships set out above leads to particularly effective decoupling of the laterally propagating parasitic radiation.

In some implementations, a ratio between an outer diameter Ds of the solid body and a diameter Dp of a pump region produced in the solid body is greater than a ratio between a refractive index ns of the solid body material and a refractive index nL of a medium which surrounds the solid body. If this condition is complied with, it is ensured that radiation emitted from the outermost edge of the pump region falls below the threshold angle of the total reflection in an azimuthal direction, which is a prerequisite for the fact that the radiation can be coupled out.

The condition Ds/Dp>ns/nL is complied with when, with a solid body material having a refractive index ns>1 and a surrounding medium with a refractive index nL (typically air with a refractive index nL=1), the diameter Dp of the pump region (the pump spot) is small enough with respect to the outer diameter Ds of the solid body. In this instance, radiation that may be spontaneously emitted from the edge of the pump spot and that expands tangentially with respect to the edge in the direction towards the outer edge of the solid body strikes the peripheral face or the outer edge of the solid body at an angle that is smaller than the angle of the total reflection in an azimuthal direction.

In some implementations, the solid-state laser arrangement further includes a focusing device for focusing pump radiation onto the plate-like solid body. To produce the pump radiation, the solid-state laser arrangement generally has a pump light source for optically pumping the plate-like solid body. The focusing device may, for example, be a parabolic mirror, in the focal plane of which the plate-like solid body is arranged. As a result of the focusing on different reflection regions of the parabolic mirror, the pump radiation of the pump light source may pass through the laser-active medium several times so that a high degree of efficiency of the solid-state laser arrangement can be achieved.

In some implementations, the solid-state laser arrangement includes a laser resonator with at least one rear mirror and one output coupling mirror. The laser resonator amplifies the laser radiation excited in the laser-active solid body medium. The rear mirror, in particular when a focusing device is used to produce multiple cycles, may be formed directly on the solid body itself (typically in the form of a reflective coating). However, the solid body may also be fitted to a redirection or folding mirror of the laser resonator.

With solid body laser arrangements having such a focusing device or such a laser resonator, which are typically operated in continuous wave (CW) mode, a relatively low inversion is achieved with a small decoupling degree. It could therefore be assumed that in this instance a decoupling of the amplified spontaneous emissions can be dispensed with. However, during the switching-on operation, the inversion is first not in equilibrium with the decoupling degree so that the provision of an inclined portion or a scatter face may also be advantageous in a solid-state laser arrangement that is operated in CW mode.

The solid-state laser arrangement may also be constructed to produce laser pulses. Pulsed laser systems are capable of producing particularly high laser powers in short, sequential time periods. To produce the laser pulses, the pump radiation (for example, using laser diodes as pump radiation sources when disc laser resonators are used) can be supplied to a conventional CW laser resonator in a pulsed manner. However, in order to produce short pulses, additional optical elements may also be provided in the solid-state laser arrangement, for example, a so-called “Q switch”, by means of which a quality switch that enables abrupt transmission of laser pulses is produced. The Q switch may be produced as an active optical element (for example, as an acoustic-optical or electro-optical modulator), but also as a passive optical element (saturable absorber).

A variant of the Q switch is constituted by “cavity dumping” in which the decoupling degree of the laser resonator is varied using the “Q switch” between 0% and 100%, that is to say, energy stored in the laser resonator is completely coupled out. Typically, an electrooptical modulator which produces a variable phase delay in the laser resonator is used as a “Q switch.”. Typically, a polarizer serves to decouple the laser pulses from the laser resonator and there is provided a delay unit that is constructed, for example, as a delay plate (phase plate) for producing a fixed phase delay in the laser resonator. The delay unit produces a constant path difference or a constant phase difference between two mutually perpendicular components of the field strength vector of the laser radiation produced at that location. A phase-shifting mirror may be provided as a delay unit in the laser resonator, that is to say, a mirror that is provided with a phase-shifting coating.

Another possibility for producing short laser pulses (up to the femtosecond range) is constituted by so-called mode coupling. In mode coupling, the longitudinal modes present in the laser are synchronized. That is, a constant mutual phase relationship of the modes is produced so that the longitudinal modes interfere in a constructive manner. In the mode coupling, shorter pulses are possible in comparison with Q switching. An active optical element, for example, an acoustic-optical or electro-optical modulator or a passive optical element (saturable absorber) or exploiting the Kerr-lens effect can be used for the mode coupling.

To produce laser pulses by Q switching, such as by “cavity dumping”, or by mode coupling, the provision of an inclined portion on the peripheral face of the plate-like solid body has been found to be particularly advantageous since, in the multiple reflection in the inclined portion, the incident angle of the laterally guided modes is reduced in each case by the inclination angle and therefore in general all guided portions may be converted into radiation modes. The provision of a scatter region can generally be dispensed with.

Other advantages will be appreciated from the description and the drawings. The features mentioned above and those set out below may also be used individually per se or together in any combination. The embodiments shown and described are not intended to be understood to be a conclusive listing but are instead of exemplary character for describing the invention.

### BRIEF DESCRIPTION OF THE DRAWINGS

FIG. 1 is a schematic illustration of a plate-like solid body that is fitted to a heat sink and in which amplified spontaneous emissions occur.

FIG. 2 is a schematic illustration of a solid-state laser arrangement with a parabolic mirror for focusing pump radiation on a plate-like solid body.

FIG. 3 is a schematic illustration of a reflection face of the parabolic mirror of FIG. 2, with eight reflection regions that are arranged in a regular manner around a center axis.

FIG. 4 is a schematic illustration of the plate-like solid body of FIG. 2 with a scatter face for decoupling spontaneous emissions.

FIG. 5 is a schematic illustration of a solid-state laser arrangement for generating cavity dumping.

FIG. 6 is a schematic illustration of a decoupling degree of the solid-state laser arrangement according to FIG. 5.

FIG. 7 is a schematic illustration of a plate-like solid body of the solid-state laser arrangement according to FIG. 5.

FIGS. 8a and 8b are a plan view and a cross-section view, respectively, of a plate-like solid body according to FIG. 7.

FIG. 8c is a schematic illustration depicting a cut-out of a plate-like solid body with gap-like recesses, in which the recesses formed on the upper side of the solid body open at an edge and have end portions that are formed in a circular manner.

### DETAILED DESCRIPTION

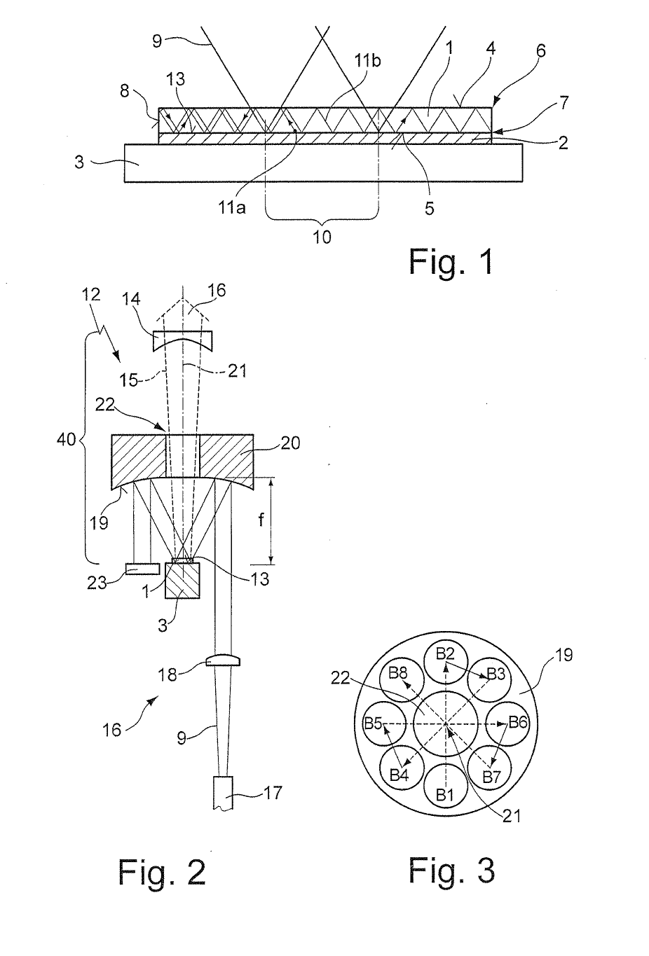

FIG. 1 shows a plate-like solid body 1 (also referred to below as a laser disc) as a laser-active medium, which is connected by an adhesive layer 2 to a heat sink 3 for cooling. The solid body 1 has an upper side 4 and a lower side 5 and a circumferential peripheral face 8 that is formed between outer edges 6, 7 of the upper side 4 and the lower side 5. The solid body 1 includes a laser-active medium with a host crystal which is doped with an active material, for example, comprising Yb:YAG, Nd:YAG or ND:YVO₄.

Through thermal and/or mechanical coupling of the adhesive layer 2, thermal energy that is produced in the solid body 1 or that is introduced into the solid body 1 can be discharged. The adhesive layer 2 may be constructed, for example, in the manner described in EP 1 178 579 A2, which is incorporated herein by reference in its entirety.

The solid body 1 may also be thermally and mechanically coupled to the heat sink 3 in a manner other than with an adhesive layer 2, for example, by bonding or soldering.

During operation of the laser disc 1, using a pump light arrangement that is not illustrated in FIG. 1, pump radiation 9 is irradiated onto a pump region 10 (pump spot) of the solid body 1 to supply it with the pump power required to produce laser radiation (by population inversion) in the laser-active medium. In this case, spontaneous emissions may occur, for example, in the pump region 10 (starting point 11a of a spontaneous emission or a photon) by multiple total reflections at the upper side 4, lower side 5 and the peripheral face 8 of the solid body 1, expand from the pump region 10 (which is typically centrally arranged in the volume of the solid body 1) to the edge of the solid body 1 and be amplified, producing amplified spontaneous emissions. The amplified spontaneous emissions of photons can be reflected back at the peripheral face 8 of the solid body 1 (as can be seen with reference to the beam path 11b of the spontaneous emission 11a in FIG. 1) so that they subsequently reach the region of the pump spot 10 again. At this location, as a result of the pump light 9 and/or by an interaction with other laterally propagating photons, there may be a further amplification of the spontaneous emissions (ASE). If the spontaneous emissions pass through the pump region 10 several times, there may be formed within the solid body 1 laterally extending laser modes that, as parasitic transverse radiation, may drastically reduce the amplification of laser modes which extend perpendicularly relative to the upper and lower side 4, 5.

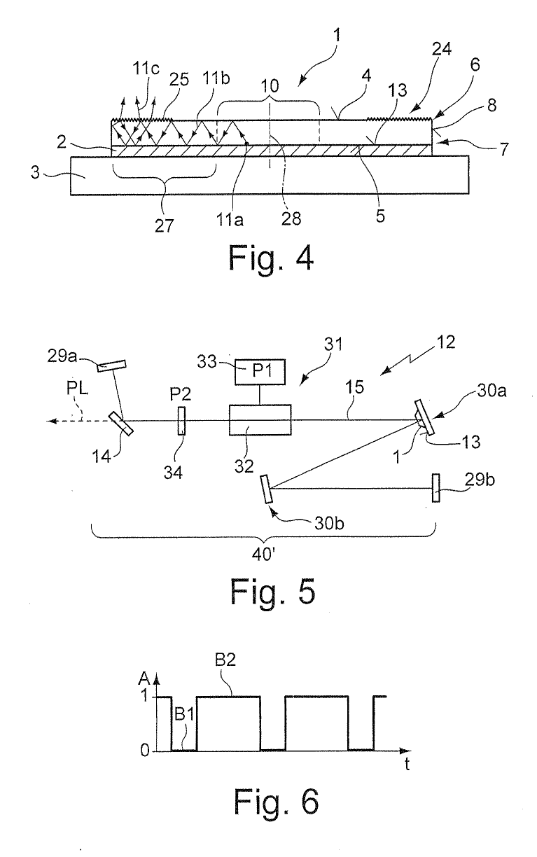

FIG. 2 shows a solid-state laser arrangement 12 that has a laser disc 1 and a heat sink 3 and that is constructed substantially as in FIG. 1 but on which a scatter region in the form of a rough scatter face is formed to decouple spontaneous emissions. The scatter face is illustrated in detail with reference to FIG. 4. At the side of the solid body 1 facing the heat sink 3 (at the lower side 5), a reflective coating 13 is applied and forms a rear mirror, which together with a partially permeable output coupling mirror 14, forms a laser resonator 40 for laser radiation 15 produced by excitation of the solid body 1 or the laser-active medium. The laser radiation 15 leaves the laser resonator 40 through the partially permeable output coupling mirror 14, as indicated in FIG. 2 by an arrow.

To excite the laser disc 1 or the laser-active medium, the solid body laser arrangement 12 has a pump light arrangement 16 having a pump light source 17, which produces an initially divergent pump light beam 9. The pump light beam 9 is collimated at an optical collimation system that is illustrated in FIG. 2 for simplification in the form of a single lens 18. The collimated pump light beam 9 strikes a reflection face 19 that is formed on a concave mirror 20. The reflection face 19 extends in a rotationally symmetrical manner with respect to a center axis 21 of the concave mirror 20 and is curved in a parabolic manner, i.e., the hollow mirror 20 forms a parabolic mirror. The collimated pump light beam 9 extends parallel with the center axis 21 of the concave mirror 20. The concave mirror 20 further has a central opening 22 for passage for the laser radiation 15 produced in the laser-active medium.

The collimated pump light beam 9 is reflected on the parabolic reflection face 19 and focused on the laser-active medium (the solid body 1), which is arranged at the focal point or the focal plane of the concave mirror 20 (with a focal distance f). In this instance, a beam exit face of the pump light source 17 is imaged onto the laser-active medium in the focal plane at an imaging scale which is defined by the focal distance f of the parabolic mirror 20 and the focal distance (not shown) of the collimation lens 18. Of course, a collimated pump light beam 9 can also be produced in another manner.

The pump light beam 9 is subsequently reflected on the reflective coating 13 at the rear side of the solid body 1, strikes the reflection face 19 in a divergent manner and is reflected once more thereon. The reflected pump light beam 9 is collimated owing to the parabolic geometry of the reflection face 19 and subsequently strikes a redirection device 23 in the form of a planar mirror which is arranged in a plane perpendicular to the center axis 21 and is reflected back in itself thereon.

In the pump diagram described above in connection with FIG. 2, it has not yet been described that the pump light beam 9, after striking the reflection face 19 for the first time and after striking the reflection face 19 for the last time, is redirected several times between reflection regions that are formed on the reflection face 19 and that are arranged in different angular ranges around the center axis 21. These reflection regions B1 to B8, as illustrated in FIG. 3, may be arranged with the same spacing around the center axis 21. The pump light beam 9 that is collimated by the lens 18 strikes the reflection face 19 at the first reflection region B1, is first reflected on the laser-active medium (the solid body 1 or the rear mirror 13) and then strikes the second reflection region B2, as indicated in FIG. 3 by a dashed arrow. From the second reflection region B2, the pump light beam 9 is redirected, by a redirection device (not shown), for example, in the form of a bi-prism, which is part of a redirection arrangement which is also not shown, onto a third reflection region B3. From there, the pump light beam 9 is reflected via the laser disc 1 onto a fourth reflection region B4 and from there via another redirection device which is not illustrated to a fifth reflection region B5, and so on until the pump light beam 9 has reached the eighth reflection region B8 at which it is reflected back in itself by the planar mirror 23 shown in FIG. 2. A reflection sequence with a larger or smaller number of reflections is also possible.

The solid-state laser arrangement 12 described according to FIG. 2 is in principle operated with comparatively high laser power, typically in CW mode. Due to the continuous pumping and in particular the multiple passing of the laser-active solid body 1 in accordance with the pump diagram illustrated in FIG. 3, such solid-state laser arrangements 12 or solid bodies 1 pumped in the manner described therein are particularly affected by the unfavorable consequences of the amplified spontaneous emission described in FIG. 1 when they are operated in the transient mode (for example, when being switched on). It has been found that, in the solid-state laser arrangement 12 shown in FIG. 2, the use of scatter faces for decoupling spontaneous emissions is particularly advantageous.

A solid body 1 for use in the solid-state laser arrangement 12 of FIG. 2 which has a scatter region 24 at the upper side 4 thereof is illustrated in FIG. 4. The scatter region 24 serves to decouple spontaneous emissions or radiation 11b that is laterally guided in the laser disc 1. Alternatively or additionally, a scatter region 24 may also be provided at the peripheral face 8 of the solid body 1. The scatter region 24 of the solid body 1 is illustrated in FIG. 4 as a zig-zag line in an edge region 27 located radially outside the pump region 10. The scatter region 24 does not the entire edge region 27, but instead is limited to a roughened surface region 25 (roughening) which adjoins the peripheral face 8. That is, the scatter region 24 is constructed as a roughened surface region 25. The roughened surface region 25 has in the present example an irregular surface structure which has a roughness Ra of between 0.01 μm and 0.5 μm, preferably between 0.1 μm and 0.3 μm or a roughness Rz between 0.5 μm and 5 μm, preferably between 1 μm and 4 μm. The roughened surface 25 forms scatter centers at the scatter region 24 in order to reduce total reflections at the upper side 4 of the laser disc 1, whereby increased decoupling of the spontaneous emissions can be brought about.

Although spontaneous emissions of photons starting from a point 11a in the pump region 10, as can be seen in FIG. 4 with reference to the beam path 11b, are reflected back and forth several times between the upper side 4 and the lower side 5 of the solid body 1 in the edge region 27 (in which the scatter region 24 is formed at the upper side 4 of the solid body 1), a portion of the spontaneous emissions from the solid body 1 can be emitted into the environment via the scatter region 24 (see beam path 11c). The decoupling at the scatter region 24 advantageously prevents new lateral propagation of the parasitic transverse radiation in the solid body 1.

The scatter region 24 in the form of the roughened surface 25 may, for example, be produced by means of a polishing method, a lapping method, a laser removal process or an ion beam process and is typically limited to the edge region 27 of the solid body 1, which extends from the outermost edge of the solid body 1 (in FIG. 4 from the peripheral face 8) in the direction of the center axis 28 of the solid body 1 (radially inwards) as far as the pump region 10. The scatter region 24 may also be formed by selective application of a layer that contains scatter members, for example, by a (thin) polymer layer, in which nanoparticles are introduced as scatter members or by a glass foam, for example, OM100 from Schott. As can be seen in FIG. 4, the scatter face 24 is limited to a radially outer portion of the edge region 27 and consequently does not extend as far as the pump region 10.

When the scatter region 24 is used, however, the diameter of the pump region 10 can be increased with respect to the diameter shown in FIG. 4 (but in principle also in FIGS. 1 to 7) since the problems described herein which are caused by damage in the edge region 27 (e.g., occurrences of particle flaking and melting of the laser crystal) as a result of small scatter centers that are provided in the solid body material and that couple out a portion of the laser power at the edge of the laser disc 1, can be prevented. An increase of the diameter of the pump region 10 may be desirable for power scaling of the solid-state laser arrangement 12.

The radial extent of the edge region 27 can be further reduced in comparison with the radius or the radial extent of the entire solid body 1 (from the peripheral face 8 to the center axis 28), as far as the region in which the scatter region 24 is formed. The edge region 27 may in particular have a radial extent which is between 30% and 50%, preferably between 35% and 45%, of the radial extent of the entire solid body 1.

The solid-state laser arrangement 12 described in FIG. 2 and FIG. 3 is typically operated in CW mode. However, the decoupling of amplified spontaneous emissions is also relevant with solid-state laser arrangements that are constructed to produce short laser pulses, as can be produced, for example, by the use of a Q switch, in particular by cavity dumping, or by mode coupling.

FIG. 5 shows such an alternative embodiment of the solid-state laser arrangement 12 for producing pulsed laser radiation PL with short pulse durations, as required in material processing operations. Such short laser pulses PL can be produced in a laser resonator 40′, for example, by cavity dumping. During pulse production, the decoupling degree A of the resonator is modulated typically between a first operating state B1 with 0% decoupling degree A and a second operating state B2 with 100% decoupling degree A, as illustrated, for example, for “cavity dumping” in FIG. 6.

A laser resonator 40′ shown in FIG. 5 is constructed to produce such a modulated decoupling degree A and has two highly reflective end mirrors 29a, 29b and a first and a second folding mirror 30a, 30b. On the first folding mirror 30a, a plate-like solid body 1 is fitted as a reinforcement medium which, during operation of the laser resonator 40′ is optically excited by the pump radiation of a pump light arrangement (not shown) and produces laser radiation 15 at a laser wavelength that is dependent on the solid body material used. At the side of the solid body 1 facing the first folding mirror 30a, a reflective coating 13 is provided.

The laser resonator further includes an electro-optical modulator 31 having a pockels cell 32 and a control device 33, and a delay unit in the form of a delay plate 34 (e.g., a birefringent crystal) whose thickness is selected in such a manner that it produces a constant phase delay P2 that corresponds to a predetermined portion of the laser wavelength for the laser radiation 15 produced in the laser resonator 40′. In the laser resonator 40′ an output coupling mirror 14 is further arranged, in which the mirror 14 is constructed as a thin-layer polariser for decoupling the laser pulses PL. With the delay plate 34 and the electro-optical modulator 31, on which a variable delay P1 can be adjusted, a modulation of the decoupling degree according to FIG. 6 can be produced together with the polarizer or output coupling mirror 14.

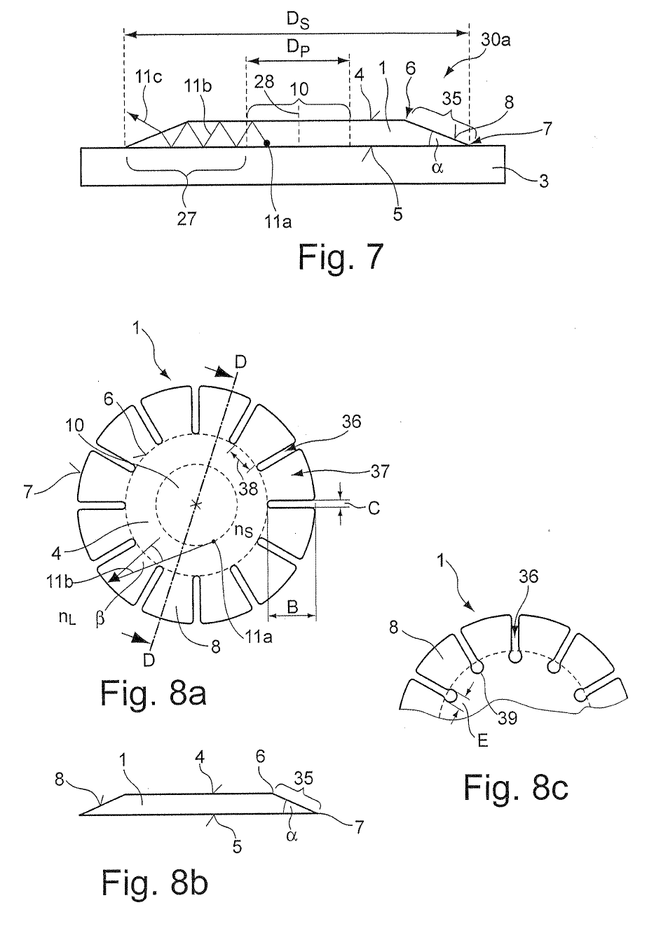

The solid body 1 has in the solid-state laser arrangement 12 shown in FIG. 5 at the peripheral face 8 thereof an inclined portion 35 that is illustrated in detail in FIG. 7. Using the inclined portion 35, spontaneous emissions from the laser-active solid body 1 can be coupled out so that an amplification of the spontaneous emissions is prevented or can at least be reduced. The inclined portion 35 extends from the outer edge 6 of the upper side 4 to the outer edge 7 of the lower side 5 of the solid body 1. That is, the peripheral face 8 in the example shown corresponds to the inclined portion 35 and the entire solid body 1 is frustoconical. The inclined portion 35 can be produced on the solid body 1, for example, by a grinding process or a laser removal process.

The upper and lower side 4, 5 of the solid body 1 extending in a mutually parallel manner forms with the inclined peripheral face 8 or the inclined portion 35 a constant inclination angle α of approximately 30°. Suitable inclination angles α generally include between 5° and 40°, preferably between 5° and 15°. Due to the inclined portion 35 (with an appropriate value of the inclination angle α) in the case of the reflection of laterally extending radiation on the peripheral face 8, the angle of incidence with each total reflection is reduced by the angle of inclination α so it is ensured that, with a sufficient number of reflections, the value falls below the threshold angle of the total reflection.

Although spontaneous emission discharged from a starting point 11a in the pump region 10 is reflected back and forth several times between the upper side 4 and the lower side 5 of the solid body 1 (see beam path 11b) in the edge region 27 in which the inclined portion 35 of the peripheral face 8 is formed, the spontaneous emission can be coupled out from the solid body 1 (see beam path 11c), such that renewed lateral propagation of the parasitic transverse radiation in the solid body 1 can be prevented or at least reduced. The pump region 10 can also extend counter to the illustration in FIG. 7 as far as the outer edge 6 of the upper side 4.

However, the reduction of the thickness of the solid body 1 along the peripheral face 8 in the inclined portion leads to a reduction of the tension resistance of the solid body 1 in this region. Such a reduced tension resistance is generally problematic since, due to different thermal expansion coefficients of the solid body 1 and the heat sink 3, a thermal loading or an expansion of the solid body when heated up may cause significant mechanical tensions. Although radial tensions can be reduced with a solid body 1 having a circumferential peripheral face 8 (as shown in FIG. 7) by an appropriate connection to the heat sink 3 (in the present example by bonding, but also by adhesion), it is not generally possible to reduce tensions acting in an azimuthal direction (i.e., in a peripheral direction) by selecting an appropriate connection technology.

FIGS. 8a,b are a plan view and a cross-section view of a solid body 1 along the line D-D of FIG. 8a, respectively, in which the azimuthal tensions are reduced. As can be seen in FIG. 8b, the solid body 1 of FIGS. 8a,b is constructed substantially in the same manner as the solid body 1 shown in FIG. 7 but has twelve recesses 36 on the peripheral face 8 to decrease tensions acting in the peripheral direction. In accordance with the number of recesses 36, the disc-like solid body 1 or the peripheral face 8 thereof is divided into twelve equally sized segments 37. That is, each segment 37 has an equally sized minimum extent 38 in the peripheral direction that is typically between approximately 500 μm and approximately 5 mm depending on the diameter of the disc-like solid body 1.

Due to the even number of twelve segments 37, the recesses 36 are diametrically opposed. That is, they extend along a common diameter. It turned out that such a diametrically opposed arrangement of the recesses 36 can, in some implementations, be disadvantageous since such an arrangement may lead to the undesirable formation of stationary waves along the common diameter. In contrast to the illustration shown in FIG. 7, it is therefore possible to provide, for example, an uneven number (for example, eleven or thirteen) segments 37 of equal size since, with such a number of segments 37, the recesses 36 are prevented from being diametrically opposite each other. Even with differently sized segments 37, it should be ensured that two mutually opposing recesses 36 do not extend along a common line.

In the example shown in FIGS. 8a,b, the recesses 36 extend in a radial direction and extend from the outer edge 7 of the lower side 5 of the solid body 1 as far as the outer edge 6 of the upper side 4 of the solid body 1 (over the entire peripheral face 8). The recesses 36 further extend in the thickness direction of the solid body 1 from the upper side 4 as far as the lower side 5 and consequently extend through the solid body 1 completely in the thickness direction. Alternatively, the recesses 36 may be constructed in a pocket-like manner. That is, the recesses 36, with the exception of directly at the lower edge 7, do not reach the lower side 5 of the solid body 1.

The transverse extent C (the width) of the recesses 36 is significantly smaller than the radial extent B (the length) of the recesses 36. Preferably, the width C of the recesses is less than 150 μm, in particular less than 110 μm. The widths can be produced, for example, by laser processing of the solid body 1. The recesses 36 do not necessarily have to extend as far as the outer edge 6 of the upper side 4 of the solid body 1. That is, the recesses 36 can be limited to a portion on the outer edge of the peripheral face 8 on which the solid body 1 has a particularly small thickness. The recesses 36 may also extend beyond the region of the inclined portion 35 of the peripheral face 8 radially further inwards, i.e., in the direction towards the center axis 28 of the solid body 1.

To reduce a notch effect which is brought about by the recesses 36 in the solid body 1, the recesses 36 may have end portions 39, whose transverse extent (width) E with respect to the transverse extent C on the peripheral face 8 is increased, as shown in FIG. 8c. The substantially circular end portions 39 of the recesses 36 reduce tension peaks in the solid body material. To reduce tensions, it is also possible to use the end portions 39 with a geometry which differs from the substantially circular geometry shown in FIG. 8c.

As can also be seen in FIG. 8a, spontaneous emission that is discharged from a starting point 11a at the edge of the pump region 10 (of the pump spot) and that expands tangentially with respect to the outer diameter Dp (see FIG. 7) of the circular pump region 10, may strike the circular outer edge 7 of the solid body 1 at an angle of incidence β (in the drawing plane of FIG. 8a, i.e., in an azimuthal direction). The diameter of the pump region 10 is defined at the lower side 5 of the solid body 1. The diameter of the pump region 10 denotes the radial extent of the region in which the pump radiation 9 is reflected in a directed manner on the lower side 5 of the solid body 1 (see FIG. 1).

The circular outer edge 7 of the solid body 1 can, as shown in FIG. 8a, be formed on a peripheral face 8 that has an inclined portion 35 or, as illustrated in FIG. 4, on a peripheral face 8 that extends at right angles with respect to the upper and lower side 4, 5. If the angle β is greater than the angle of the total reflection, in both cases the radiation is thrown back at the peripheral face 8 and can in another passage be amplified by the solid body 1. However, if the spontaneous emission leaves the pump region 10 in a non-tangential manner, the angle of incidence β on the outer edge 7 or on the peripheral face 8 is smaller so that the tangential emission of radiation from the pump region 10 constitutes an unfavorable case with respect to the total reflection.

Taking into account the definition of the threshold angle of the total reflection in accordance with the refractive indices of the media involved, and the geometric size relationships of the solid body 1 or the pump region 10, when the condition Ds/Dp>ns/nL is complied with (i.e., the ratio between the outer diameter Ds of the solid body 1 and the diameter Dp of the pump region 10 (pump spot) is greater than the ratio between the refractive index ns of the solid body material and the refractive index nL of the medium surrounding the solid body 1, generally air with nL=1), there is no azimuthal total reflection at the peripheral face 8 or in FIG. 8a at the outer edge 7 so that the beam path 11b of the spontaneous emission continues outside the solid body 1.

In the manner described with reference to the above examples, amplified spontaneous emissions can be suppressed in an effective manner so that high powers can be produced with the laser disc 1. The method described herein can also be carried out with laser discs 1 that are not planar and that have a constant spherical curvature. The geometry of the laser disc 1 is also not limited to a round shape; instead the laser disc 1 may, for example, have a square or rectangular geometry.

A number of embodiments have been described. Nevertheless, it will be understood that various modifications may be made without departing from the spirit and scope of the invention. Accordingly, other embodiments are within the scope of the following claims.

What is claimed is:

1. A solid-state laser arrangement, comprising:
a plate-like solid body with a laser-active medium, wherein the plate-like solid body comprises an upper side, a lower side and a circumferential peripheral face; and
a heat sink thermally coupled to the lower side of the plate-like solid body,
wherein the plate-like solid body comprises a scatter region on the upper side and/or on the peripheral face, and/or wherein the peripheral face of the plate-like solid body comprises a portion inclined relative to the upper side and the lower side.

2. The solid-state laser arrangement according to claim 1, wherein the scatter region is a roughened face.

3. The solid-state laser arrangement according to claim 1, wherein the inclined portion extends from the upper side to the lower side of the plate-like solid body.

4. The solid-state laser arrangement according to claim 1, wherein an inclination angle (α) of the inclined portion is constant along the peripheral face.

5. The solid-state laser arrangement according to claim 4, wherein the angle of inclination (α) is between 5° and 40°.

6. The solid-state laser arrangement according to claim 1, wherein recesses are on the peripheral face, the recesses extending from an outer edge of the lower side of the plate-like solid body in a direction towards an outer edge of the upper side of the plate-like solid body.

7. The solid-state laser arrangement according to claim 6, wherein the recesses divide the peripheral face into a plurality of segments that are the same size.

8. The solid-state laser arrangement according to claim 7, wherein the segments in the peripheral direction have a size between 500 μm and 5 mm.

9. The solid-state laser arrangement according to claim 7, wherein the recesses are less than 150 μm wide.

10. The solid-state laser arrangement according to claim 6, wherein each one of the segments is located in a region of the peripheral face diametrically opposite a corresponding recess.

11. The solid-state laser arrangement according to claim 6, wherein each recess in the region of the outer edge of the upper side of the plate-like solid body comprises an end portion, wherein, for each recess, a transverse extent of the end portion is larger than a transverse extent of the recess on the peripheral face.

12. The solid-state laser arrangement according to claim 1, wherein the scatter region and/or the inclined portion are located in an edge region of the solid body, wherein the edge region extends from an outer edge of the solid body in a direction towards a center axis of the solid body, the edge region being between 30% and 50% of the solid body from the outer edge to the center axis.

13. The solid-state laser arrangement according to claim 1, wherein a ratio between an outer diameter of the solid body and a diameter of a pump region produced in the solid body is greater than a ratio between a refractive index of the solid body and a refractive index of a medium which surrounds the solid body.

14. The solid-state laser arrangement according to claim 1, further comprising: a focusing device arranged to focus pump radiation onto the plate-like solid body.

15. The solid-state laser arrangement according to claim 1, further comprising a laser resonator comprising at least one rear mirror and one output coupling mirror.
